(19) United States
(12) Patent Application Publication
(10) Pub. No.: US 2008/0047993 A1
(43) Pub. Date: Feb. 28, 2008

(54) Roof rack and method of using same

(76) Inventors: Donald W. Wooten, Arlington, TX (US); Gary Hemby, Burleson, TX (US); Robert Alan Woodmansee, Dallas, TX (US)

Correspondence Address: DUNLAP CODDING & ROGERS, P.C., PO BOX 16370, OKLAHOMA CITY, OK, 73113, US

(21) Appl. No.: 11/511,161

(22) Filed: Aug. 28, 2006

(51) Int. Cl. B60R 9/00

(52) U.S. Cl. 224/325

(57) ABSTRACT

A roof rack connectable to a roof of a vehicle, the roof having a roof hole formed therethrough. The roof rack is provided with at least one cross support assembly for supporting a load above the roof of the vehicle. The cross support assembly includes at least one cross support, and at least one hole clearance device connected to the cross support and adapted to conform about at least a portion of the roof hole when the roof rack is installed on the vehicle. The roof rack is also provided with at least one connector support assembly to connect the roof rack to the roof of the vehicle.

### CROSS-REFERENCE TO RELATED APPLICATIONS

Not applicable.

### BACKGROUND OF THE INVENTION

Roof racks add additional cargo capacity to vehicles and are useful for transporting a variety of materials. For military vehicles in particular, roof racks can provide a valuable place to stow personal gear such as duffel bags, as well as other material such as water, ammunition, concertina wire, etc. Some roof racks are permanently attached to the vehicle such that removal of the roof rack damages the vehicle. Other roof racks are removable without noticeable damage. Some roof racks are removable and adaptable to fit different vehicles. These roof racks typically stretch from one side of the roof to the other, covering much of the roof and connecting to the rain gutters or the door frames. The cross support of such roof racks extend from one side of the roof to the other in a linear fashion, and perpendicular to the directional movement of the vehicle. The lateral supports extend perpendicular to the cross support. Military vehicles which have a large opening extending through the roof for use with a gun turret are known in the art, examples of these vehicles are known in the art as “family of Medium Tactical Vehicles” (“FMTV”) and “Light Medium Tactical Vehicles” (“LMTV”). Prior roof racks interfere with the opening in the roofs of these vehicles.

Thus there is a need for a load to be carried on the roof of a vehicle with such a roof opening, without the roof rack interfering with the opening or an assembly extending therefrom, such as a gun turret. It is to such a roof rack that the present invention is directed.

### BRIEF DESCRIPTION OF THE SEVERAL VIEWS OF THE DRAWINGS

FIG. 1 is a perspective view of an exemplary roof rack, constructed in accordance with the present invention, mounted on a vehicle having a roof hole.

FIG. 2 is a top plan view of the roof rack depicted in FIG. 1.

FIG. 3 is an exploded, perspective view of an exemplary roof rack kit utilized to form the roof rack depicted in FIGS. 1 and 2.

FIG. 4 is a top plan view of the roof rack showing its relation to the substructure of the roof of the vehicle.

FIG. 5 is a side elevation view of an exemplary vibration reduction devie utilized in accordance with the present invention.

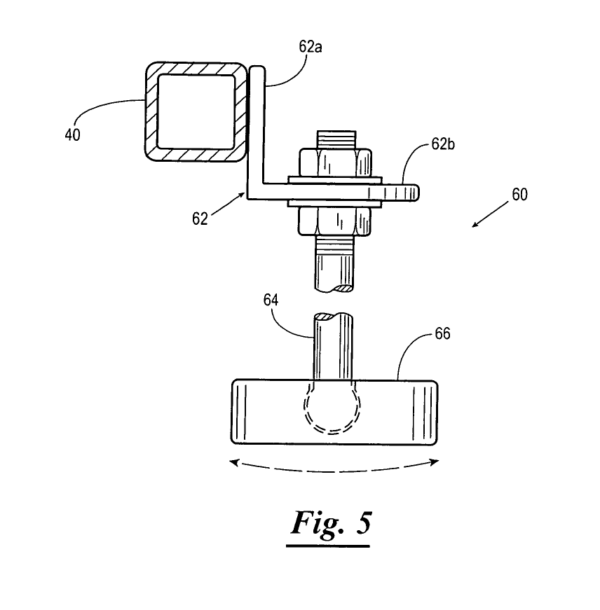

### DETAILED DESCRIPTION OF THE INVENTION

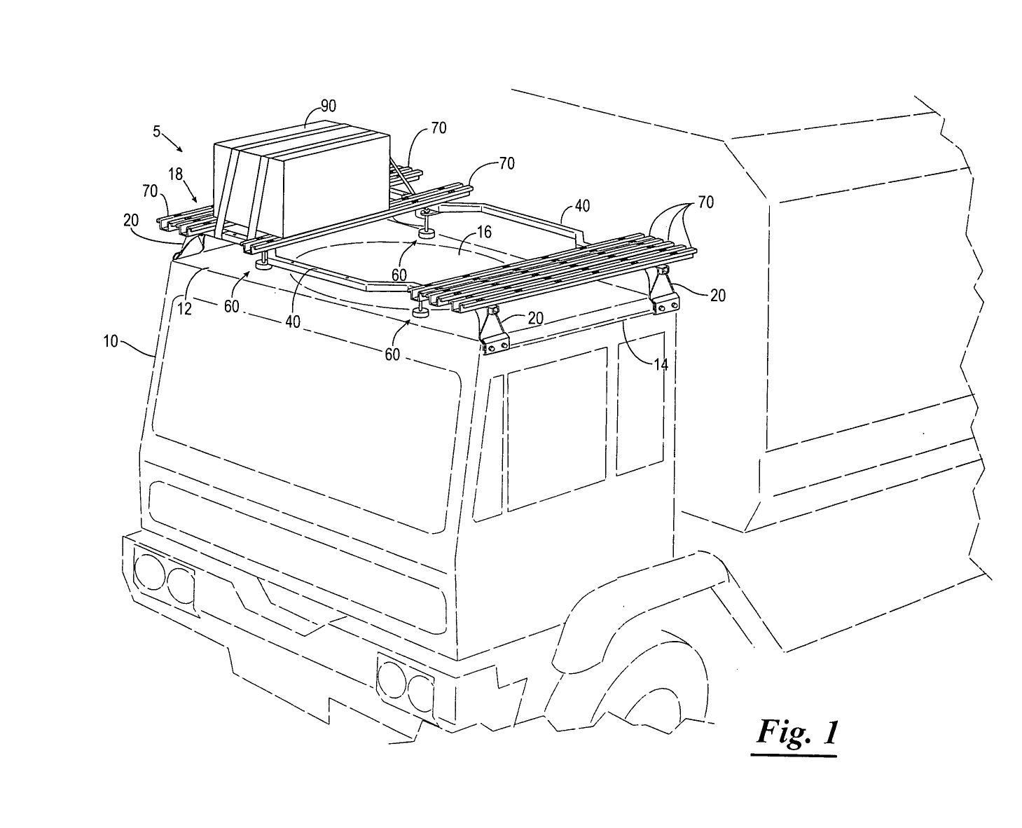

Referring now to the figures, and more particularly to FIG. 1, a vehicle assembly 5 constructed in accordance with the present invention is shown. The vehicle assembly 5 is provided with a vehicle 10, a roof rack 18, and a load 90. The vehicle 10 includes a roof 12 having a rain gutter 14 and a roof hole 16.

The roof 12 is a protective covering or support on top of the vehicle 10, and may be rigid or flexible, permanent or removable, and continuous or non-continuous. The roof hole 16 can be any shape including but not limited to circular, square, triangular, projecting inwards, projecting outwards, and the like. The load 90 is any load that would be carried on the roof 12 of the vehicle 10; including duffel bags, luggage, and other material such as water, ammunition, concertina wire, etc. The vehicle 10 can be but is not limited to a Family of Medium Tactical Vehicle (FMTV) or a Light Medium Tactical Vehicle Systems (LMTV).

The roof rack 18 is suitable for a personal, commercial, or military vehicle with a roof 12. The roof rack 18 is adaptable to fit different vehicles and it may cover all or a portion of the roof 12 of vehicle 10.

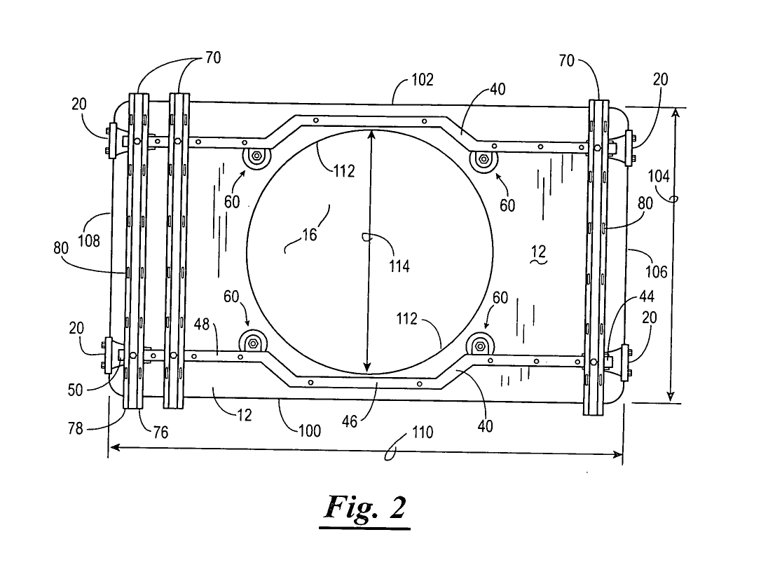

Referring now to FIGS. 2-4, the roof rack 18 includes at least one connector support assembly 20, at least one cross support assembly 40 at least one vibration reduction device 60, and at least one lateral support 70. In the example shown, the roof rack 18 includes four connector support assemblies 20, two cross support assemblies 40, four vibration reduction devices 60 and a plurality of lateral supports 60. Each of the connector support assemblies 20 are similar in construction and function. Thus, only one connector support assembly 20 will be described in detail. Each of the cross support assemblies 40 are similar in construction and function, with the exception that the rear cross support assembly is rotated approximately 180 degrees about its longest axis and installed such that it forms the mirror image of the front cross support assembly 40, although the cross support assemblies may have different shapes. Thus, only one cross support assembly 40 will be described in detail. In a preferred embodiment, each of the vibration reduction devices 60 are similar in construction and function. Thus, only one vibration reduction device 60 will be described in detail. Each of the lateral supports 70 are also similar in construction and function. Thus, only one lateral support 70 will be described in detail.

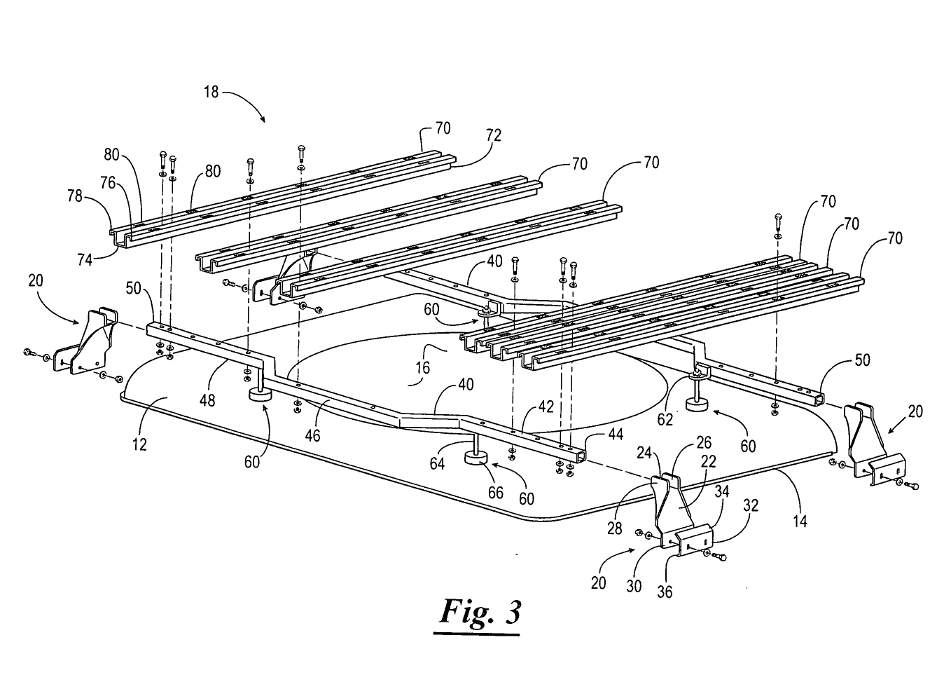

In the example shown in FIG. 3, the connector support assembly 20 includes a support member 22 and a clamp member 32. The support member 22 has a receiving portion 24 and a base portion 30. The base portion 30 typically extends downwardly from the support member 22 at an angle such that the base portion 30 can be inserted into the rain gutter 14. The receiving portion 24 has a first support wing 26 and a second support wing 28, which are substantially perpendicular to the plane of the base portion 30. Support wings 26 and 28 are spaced apart to form a channel therebetween to receive the cross support assembly 40.

The clamp member 32 has a retaining tab 34 and an attachment tab 36. The retaining tab 34 typically extends upwardly from the clamp member 32 at an angle to contact at least a portion of support member 22 and provide a downward clamping force on support member 22 between retaining tab 34 and rain gutter 14. The attachment tab 36 extends downward from the clamp member 32 at an angle to contact at least a portion of the rain gutter 14 and provide clamping force on the rain gutter 14 between the attachment tab 36 and the base portion 30.

The clamp member 32 is connected to the base member 22 by any suitable connecting means such as screws, bolts, adhesive, interlocking elements, magnetism, welds, and the like. The connector support assembly 20 can be forged, cast, stamped, or otherwise formed out of any suitably durable material. Optionally, each of the connector support assemblies 20 can include cushion assemblies, such as rubber pads to engage the vehicle 10 without marring the vehicle 10 or the roof 12.

The cross support assembly 40 includes a first support portion 42 defining an end 44, a hole clearance portion 46, and a second linear support portion 48 defining a second end 50. In the embodiment shown, the ends 44 and 50 are received between support wings 26 and 28 and coupled to the connector support assembly 20 via support member 22. In other embodiments, the ends 44 and 50 may be adapted to bolt directly to the connector support assemblies 20, fit over or around the connector support assemblies 20, or attach by any other suitable means. The hole clearance portion 46 is shaped to at least partially circumscribe or avoid the roof hole 16 in the roof 12. In this manner, clearance is provided between the cross support assembly 40 and at least a portion of the roof hole 16 so as to avoid interference with the use of the roof hole 16.

The hole clearance portion 46 and the support portions 42 and 48 can be constructed as integral portions of a single piece or can be constructed as separate components which are subsequently connected. For example, the cross support assembly 40 can be constructed from a single metal tube which is bent into the shape shown. The support portions 42 and 48 can be provided with a variety of shapes such as linear, zig-zag, rectangular, or the like.

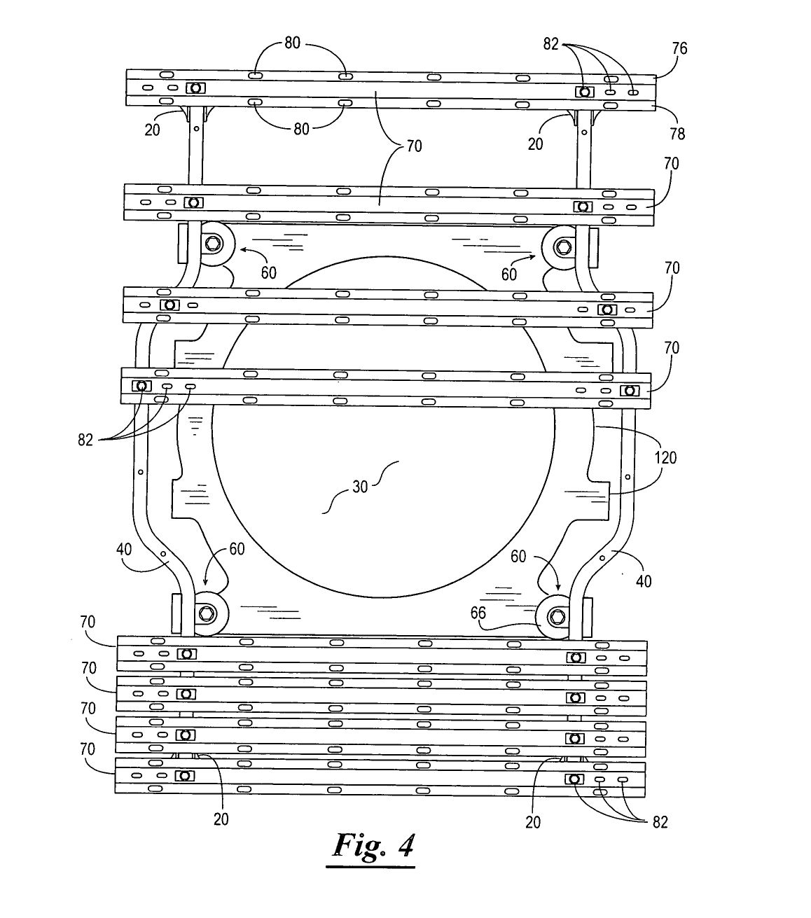

In one embodiment, the lateral support 70 has a plurality of connection points 82 (FIG. 4) to adjustably connect to either the support portions 42 and 48 or the hole clearance portion 46 of cross support assembly 40, such that the lateral supports 70 may either traverse or avoid the roof hole 16 depending on whether the roof hole 16 will be used when the roof rack 18 is installed on the roof 12.

The lateral support 70 has a substantially U-shaped cross section, the U-shaped cross section forming a channel between a first end 72 and a second end 74 of the lateral support 70. The lateral support 70 is further defined as having a pair of L-shaped flanges 76 and 78 located on opposite sides of the channel and running along the full length of the lateral support 70. The L-shaped flanges 76 and 78 each have a plurality of holes 80 defined through the horizontal surface of L-shaped flanges 76 and 78, the holes 80 (FIGS. 3 and 4) providing tying points for securing the load 90 with rope, straps, bungee cords, and the like.

Although the connection points 82 are shown as several individual holes, it will be understood that the plurality of connection points 82 may also be provided by a single, elongated hole or by any other suitable fastening means that allows the lateral support 70 to be adjustably connected to either the support portions 42 and 48 or the hole clearance portion 46 of the cross support assembly 40.

The cross support assemblies 40 and the lateral supports 70 can have a variety of cross-sectional shapes, such as circular, triangular, U-shaped, L-shaped, and the like. The cross support assemblies 40 and lateral supports 70 are preferably constructed of one or more rigid materials such as 12 gauge ASTM A653 steel or any other suitably rigid and durable material. In this embodiment of the invention, the lateral supports 70 are coupled with the cross support assemblies 40 by nuts and bolts. However, any suitable fastening means may be utilized such as screws, nails, bolts, brackets, clamps, clips, glue, hangers, hooks, magnetism, rivets, suction cups, ties, velcro, and the like.

The vibration reduction device 60 has a mount 62, a linkage 64, and a vibration reduction pad 66. The vibration reduction mount 62 can be substantially L-shaped, with a vertical element 62a connecting to the cross support assembly 40 and a horizontal element 62b connecting to the linkage 64. The linkage 64 is adjustably connected to the mount 62 and extends to the vibration reduction pad 66, the linkage 64 being typically oriented substantially perpendicular to the plane of the roof 12. The linkage 64 is preferably adjusted such that the vibration reduction pad 66 firmly contacts the roof 12. The vibration reduction pad 66 can be attached to the lower end of the linkage 64 for example and is constructed of a material with suitable vibration damping properties such as rubber, latex, synthetic elastomer, composite, or the like. In the preferred embodiment, the vibration reduction pad 66 is connected to linkage 64 via a ball joint or other pivoting means, such that the vibration reduction pad can adjust to substantially meet the contour of the roof 12. The vibration reduction device 60 is preferably attached to the cross support assembly 40 such that the vibration reduction pad 66 is positioned over the substructure 120 (FIG. 4) of the roof 12. In one embodiment, the vibration reduction pad 66 is shaped as a 6 ″ diameter disk, however, the size and shape of the vibration reduction pad 66 can vary.

The linkage 64 can be a tube or bolt constructed of a durable material such as steel, aluminum, or the like. However, it is understood that the linkage 64 may alternatively be constructed from a flexible or elastomeric material or may include vibration damping elements such as hydraulic, pneumatic, or spring mechanisms.

As best shown in FIG. 2, the roof 12 is provided with a front edge 100, a rear edge 102, and a length 104 extending therebetween. The roof 12 is also provided with a first side 106, a second side 108, and a width 110 extending therebetween. The roof hole 16 has an outer boundary 112, having a width 114. The outer boundary 112 typically encompasses a major portion of the length 104 of the roof 12, such that the outer boundary 112 is adjacent to the front edge 100 and adjacent to the rear edge 102.

The embodiment depicted in FIGS. 24 includes four connector support assemblies 20, two cross support assemblies 40, four vibration reduction devices 60, and a plurality of lateral supports 70.

Two connector support assemblies 20 are attached along the first side 106 and two connector support assemblies 20 are attached along the second side 108. On each side of the roof 12, one connector support assembly 20 is attached near the front edge 100 of the roof 12 and one connector support assembly 20 is attached near the rear edge 102 of the roof 12. In the embodiment shown, each cross support assembly 40 has its first end 44 coupled to a connector support assembly 20 attached to the first side 106 and each cross support assembly 40 has its second end 50 coupled to a connector support assembly 20 attached to the second side 108. As shown, the front and rear cross support assemblies 40 are installed in mirror opposite positions to one another such that their respective hole clearance portions 46 partially circumscribe or avoid the hole 16 in the roof 12. It should be understood that the cross support assemblies 40 could be rotated approximately 90 degrees and spaced a distance apart along the width 110 of the roof 12.

Two vibration reduction devices 60 are preferably attached to each of the cross support assemblies 40 such that two of the four total vibration pads 66 are located at least partially over the substructure 120 (FIG. 4) of the roof 12 on either side of the hole 16.

The preferred embodiment of the roof rack 18 is further shown with a plurality of lateral supports 70. The lateral supports 70 are attached to the cross supports 40 such that the longest axis of the lateral support 70 is substantially parallel to the direction of travel of the vehicle 10.

Referring now to FIG. 3, shown therein is an exploded view of a roof rack kit 118 positioned adjacent to the roof 12 for forming the roof rack 18. The roof rack kit 118 includes four connector support assemblies 20, two cross support assemblies 40, four vibration reduction devices 60, and a plurality of lateral supports 70. A variety of hardware is also included, such as nuts, bolts and washers for interconnecting the connector support assemblies 20, cross support assemblies 40, and lateral supports 70. The roof rack kit 80 can be positioned in a package (not shown), such as a box, a bag, a band, a heat shrinkable material, plastic wrap, tube, or the like.

To form the roof rack 18, two connector support assemblies 20 are attached to the first side 106 of the roof 12 and two connector support assemblies 20 are attached to the second side 108 of the roof 12. The connector support assemblies 20 are positioned along the second side 108 directly across from the connector support assemblies 20 that are attached to the first side 106.

Two vibrator support assemblies 60 are then connected to each of the two cross support assemblies 40 in pre-determined locations corresponding to the substructure 120 of the roof 12. Or, the vibration support devices 60 can be pre-assembled with the cross support assemblies 40. Each cross support assembly 40 is then connected to the corresponding pair of connector support assemblies 20 to stabilize the connector support assemblies 20 and support the cross support assemblies 40 an appropriate distance above the roof 12. The cross support assemblies 40 are attached such that their respective hole clearance portions 46 partially circumscribe or avoid the hole 16 in the roof 12. The lateral supports are then positioned on top of the cross support assemblies 40 and attached thereto to strengthen the cross support assemblies 40 and distribute the load 90 between the cross support assemblies 40. Then, the linkages 64 are adjusted to position the vibration reduction pads 66 on the roof 12. The linkages 64 are adjusted so that the vibration reduction pads 66 lightly contact the roof 12 prior to placing the load 90 on the lateral supports 70. To disassemble the roof rack 18, the process discussed above is generally reversed.

In view thereof, it can be seen that only one of the roof rack kit 118 is necessary to construct a variety of different configurations of roof racks while providing clearance for the roof hole 16 in the roof 12 of the vehicle 10. Other advantages of the roof rack 18 will become apparent to those skilled in the art upon a review of the foregoing written description, the attached drawings and the appended claims.

For example, one particular use of the roof rack 18 is when the vehicle 10 is capable of having a turret ring mounted within the roof hole 16. When used with these types of vehicles 10, the lateral supports 70 may be used in two different positions: (a) without the turret ring in place, the lateral supports 70 can be evenly distributed across the cross support assemblies 40; (b) with the turret ring in place the lateral supports 70 can be mounted on the cross support portions 42 and 48 of the cross support assemblies 40 to prevent obstruction for the turret ring to move freely while creating two additional areas on either side of the vehicle 10 to store the load 90.

The figures are not necessarily to scale and certain features and certain views of the figures may be shown exaggerated in scale or in schematic in the interest of clarity and conciseness.

It will be understood from the foregoing description that various modifications and changes may be made in the preferred and alternative embodiments of the present invention without departing from its true spirit.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

1. A roof rack connectable to a roof of a vehicle, the roof having a roof hole formed therethrough, the roof rack comprising:
at least one cross support assembly to support a load above the roof of the vehicle, the cross support assembly comprising:
at least one cross support portion;
at least one hole clearance portion connected to the cross support portion and shaped to avoid at least a portion of the roof hole when the roof rack is installed on the vehicle; and,
at least one connector support assembly to support the cross support assembly and connect the roof rack to the vehicle.

2. The roof rack of claim 1, further comprising at least one lateral support, connected to the cross support assembly.

3. The roof rack of claim 2, wherein the cross support assembly is adapted to selectively connect to the lateral support at one of several locations so as to position the lateral support to at least partially avoid the roof hole when the roof rack is installed on the roof of the vehicle.

4. The roof rack of claim 3, wherein the lateral support is adapted to selectively connect to the cross support assembly at one of several locations so as to position the lateral support to at least partially avoid the roof hole when the roof rack is installed on the roof of the vehicle.

5. The roof rack of claim 2, wherein the lateral support is adapted to selectively connect to the cross support assembly at one of several locations so as to position the lateral support to at least partially avoid the roof hole when the roof rack is installed on the roof of the vehicle.

6. The roof rack of claim 1, further comprising at least one vibration reduction device.

7. The roof rack of claim 6, wherein the vibration reduction device comprises:
a mount connecting the vibration reduction device to the roof rack;
a vibration reduction pad contacting the roof of the vehicle to dampen or otherwise reduce the vibration of the roof rack; and,
a linkage connecting the vibration reduction pad to the mount.

8. The roof rack of claim 6, wherein the vibration reduction device comprises at least one element from the group including hydraulic, pneumatic, and spring mechanisms.

9. The roof rack of claim 1, wherein the vehicle is a military vehicle.

10. The roof rack of claim 1, wherein the roof rack covers only a portion of the roof of the vehicle.

11. A roof rack connectable to the roof of a vehicle, the roof having a front edge, a back edge, and a roof hole having an outer boundary encompassing a major portion of the roof, the outer boundary positioned adjacent to the front edge and the back edge of the roof, the roof rack comprising:
at least one cross support assembly to support a load above the roof of the vehicle, the cross support assembly comprising:
at least one cross support portion;
at least one hole clearance portion connected to the cross support portion and shaped to avoid the roof hole when the roof rack is installed on the vehicle; and,
at least one connector support assembly to support the cross support assembly and connect the roof rack to the vehicle.

12. The roof rack of claim 11, further comprising at least one vibration reduction device.

13. The roof rack of claim 12, wherein the vibration reduction device comprises:
a mount connecting the vibration reduction device to the roof rack;
a vibration reduction pad contacting the roof of the vehicle to dampen or otherwise reduce the vibration of the roof rack; and,
a linkage connecting the vibration reduction pad to the mount.

14. The roof rack of claim 12, wherein the vibration reduction device comprises at least one element from the group including hydraulic, pneumatic, and spring mechanisms.

15. A roof rack connectable to a roof of a vehicle, the roof having a roof hole formed therethrough, the roof rack comprising:
at least two cross support assemblies to support a load above the roof of the vehicle, each of the cross support assemblies comprising:
at least one cross support portion;
at least one hole clearance portion connected to the cross support portion and shaped to avoid at least a portion of the roof hole when the roof rack is installed on the vehicle; and,
at least four connector support assemblies to support the cross support assemblies and connect the roof rack to the vehicle.

16. The roof rack of claim 15, wherein one connector support assembly is positioned near each end of a cross support assembly.

17. The roof rack of claim 15, further comprising at least one vibration reduction device.

18. The roof rack of claim 17, wherein the vibration reduction device comprises:
a mount connecting the vibration reduction device to the roof rack;
a vibration reduction pad contacting the roof of the vehicle to dampen or otherwise reduce the vibration of the roof rack; and,
a linkage connecting the vibration reduction pad to the mount.

19. The roof rack of claim 17, wherein the vibration reduction device comprises at least one element from the group including hydraulic, pneumatic, and spring mechanisms.

20. The roof rack of claim 15, further comprising at least four vibration reduction devices.

21. The roof rack of claim 20, wherein two vibration reduction devices are positioned on each cross support assembly, the two vibration reduction devices disposed in spaced-apart relation to each other.
